(19) United States
(12) Patent Application Publication
(10) Pub. No.: US 2012/0141287 A1
(43) Pub. Date: Jun. 7, 2012

(54) WIND TURBINE ROTOR BLADE JOINT

(75) Inventors: Daniel Alan Hynum, Simpsonville, SC (US); Charles Erklin Seeley, Niskayuna, NY (US); Bruce Clark Busbey, Greer, SC (US); Brandon Shane Gerber, Charleston, SC (US); Peggy Lynn Baehmann, Glenville, NY (US); Roger Neal Johnson, Hagaman, NY (US)

(73) Assignee: GENERAL ELECTRIC COMPANY, Schenectady, NY (US)

(21) Appl. No.: 13/220,044

(22) Filed: Aug. 29, 2011

(51) Int. Cl. F03D 1/06

(52) U.S. Cl. 416/235

(57) ABSTRACT

A joint for connecting a first blade segment and a second blade segment of a wind turbine rotor blade is disclosed. The joint includes a body, the body including an outer surface and an inner surface. The outer surface has an aerodynamic contour that generally corresponds to an aerodynamic contour of the first blade segment and the second blade segment. The body includes a pressure side and a suction side extending between a leading edge and a trailing edge. In some embodiments, the joint further includes a channel defined in the outer surface of the body. The channel includes a generally continuous base wall extending between opposing sidewalls. The inner surface includes the base wall. In other embodiments, the joint further includes a channel defined in the body, and a shell extending from the body in a generally span-wise direction.

### FIELD OF THE INVENTION

The present disclosure relates in general to wind turbine rotor blades, and more particularly to joints for connecting blade segments in wind turbine rotor blades.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The size, shape, and weight of rotor blades are factors that contribute to energy efficiencies of wind turbines. An increase in rotor blade size increases the energy production of a wind turbine, while a decrease in weight also furthers the efficiency of a wind turbine. Furthermore, as rotor blade sizes grow, extra attention needs to be given to the structural integrity of the rotor blades. Presently, large commercial wind turbines in existence and in development are capable of generating from about 1.5 to about 12.5 megawatts of power. These larger wind turbines may have rotor blade assemblies larger than 90 meters in diameter. Additionally, advances in rotor blade shape encourage the manufacture of a forward swept-shaped rotor blade having a general arcuate contour from the root to the tip of the blade, providing improved aerodynamics. Accordingly, efforts to increase rotor blade size, decrease rotor blade weight, and increase rotor blade strength, while also improving rotor blade aerodynamics, aid in the continuing growth of wind turbine technology and the adoption of wind energy as an alternative energy source.

As the size of wind turbines increases, particularly the size of the rotor blades, so do the respective costs of manufacturing, transporting, and assembly of the wind turbines. The economic benefits of increased wind turbine sizes must be weighed against these factors. For example, the costs of pre-forming, transporting, and erecting a wind turbine having rotor blades in the range of 90 meters may significantly impact the economic advantage of a larger wind turbine.

One known strategy for reducing the costs of pre-forming, transporting, and erecting wind turbines having rotor blades of increasing sizes is to manufacture the rotor blades in blade segments. The blade segments may be assembled to form the rotor blade after, for example, the individual blade segments are transported to an erection location. However, known devices and apparatus for connecting the blade segments together may have a variety of disadvantages. For example, many known devices and apparatus must be accessed and connected to blade segments internally, thus requiring significant and difficult labor for such connections. Additionally, the application of, for example, a bonding material to known devices may be difficult. For example, known devices may cause difficulties in observing and inspecting the injection or infusion of bonding material between adjacent blade segments. Further, known connection devices generally do not allow for disassembly after the rotor blade has been formed, thus preventing the removal of individual blade segments for inspection, maintenance, replacement, or upgrading.

Accordingly, there is a need for a wind turbine rotor blade design that is particularly adaptable for larger wind turbines, and which minimizes the associated transportation and assembly costs of the wind turbine without sacrificing the structural rigidity and energy efficiencies of the wind turbine. More specifically, there is a need for a blade joint for wind turbine rotor blade segments that simplifies the assembly of the blade segments into a rotor blade, that allows more accurate assembly of the blade segments into a rotor blade, and that allows for disassembly of the individual blade segments as required or desired after assembly.

### BRIEF DESCRIPTION OF THE INVENTION

Aspects and advantages of the invention will be set forth in part in the following description, or may be obvious from the description, or may be learned through practice of the invention.

In one embodiment, a joint for connecting a first blade segment and a second blade segment of a wind turbine rotor blade is disclosed. The joint includes a body, the body including an outer surface and an inner surface. The outer surface has an aerodynamic contour that generally corresponds to an aerodynamic contour of the first blade segment and the second blade segment. The body includes a pressure side and a suction side extending between a leading edge and a trailing edge. The joint further includes a channel defined in the outer surface of the body. The channel includes a generally continuous base wall extending between opposing sidewalls. The inner surface includes the base wall.

In another embodiment, a joint for connecting a first blade segment and a second blade segment of a wind turbine rotor blade is disclosed. The body includes an outer surface and an inner surface. The outer surface has an aerodynamic contour that generally corresponds to an aerodynamic contour of the first blade segment and the second blade segment. The body includes a pressure side and a suction side extending between a leading edge and a trailing edge. The joint further includes a channel defined in the body, and a shell extending from the body in a generally span-wise direction. The shell has a generally aerodynamic contour. A thickness of the shell tapers from the body in the generally span-wise direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an exemplary wind turbine;

FIG. 2 is a perspective view of a wind turbine rotor blade according to one embodiment of the present disclosure;

FIG. 3 is a perspective view of a joint connected to a blade segment according to one embodiment of the present disclosure;

FIG. 4 is a cross-sectional view of a joint as shown in FIG. 3 connecting two blade segments according to one embodiment of the present disclosure;

FIG. 5 is a perspective view of a joint connected to a blade segment according to another embodiment of the present disclosure;

FIG. 6 is a cross-sectional view of a joint as shown in FIG. 5 connecting two blade segments according to another embodiment of the present disclosure;

FIG. 7 is a cross-sectional view, along the lines 7-7 of FIG. 5, of a joint connecting two blade segments according to another embodiment of the present disclosure; and

FIG. 8 is a perspective view of a joint according to another embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

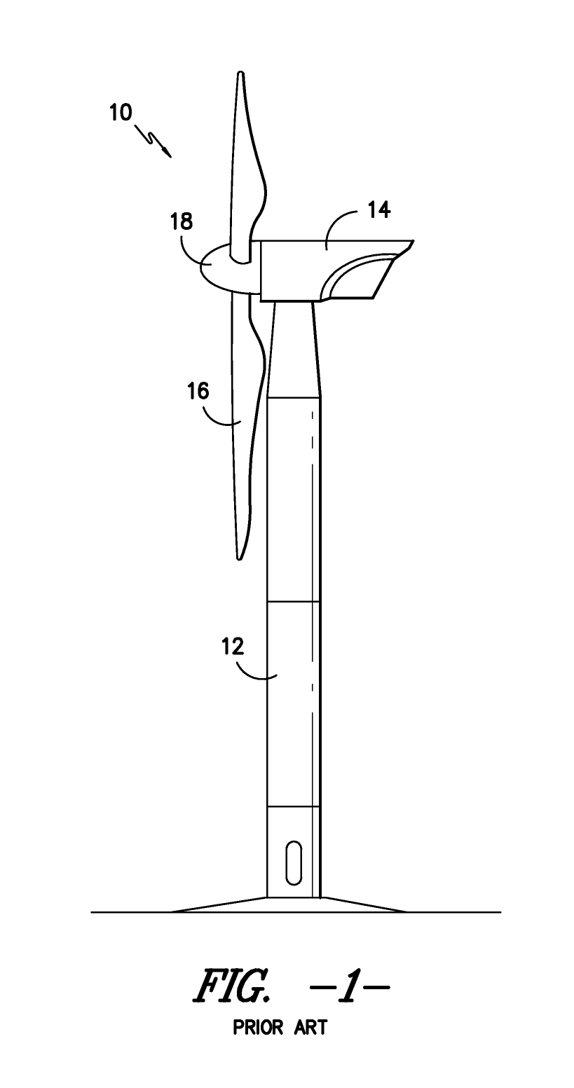

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft, as discussed below. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

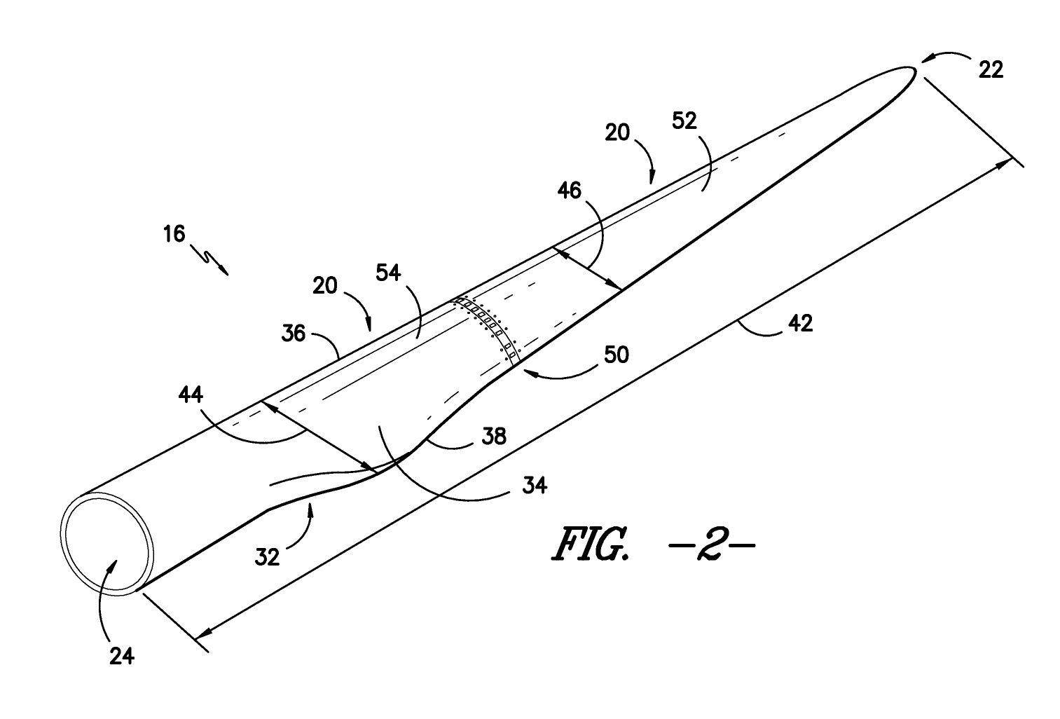

Referring to FIG. 2, one embodiment of a rotor blade 16 in accordance with the present disclosure is shown. The rotor blade 16 may include a plurality of individual blade segments 20 aligned in an end-to-end order from a blade tip 22 to a blade root 24. Each of the individual blade segments 20 may be uniquely configured so that the plurality of blade segments 20 define a complete rotor blade 16 having a designed aerodynamic profile, length, and other desired characteristics. For example, each of the blade segments 20 may have an aerodynamic contour that corresponds to the aerodynamic contour of adjacent blade segments 20. Thus, the aerodynamic contours of the blade segments 20 may form a continuous aerodynamic contour of the rotor blade 16.

In general, the rotor blade 16, and thus each blade segment 20, may include a pressure side 32 and a suction side 34 extending between a leading edge 36 and a trailing edge 38. Additionally, the rotor blade 16 may have a span 42 and a chord 44. The chord 44 may change throughout the span 42 of the rotor blade 16. Thus, a local chord 46 may be defined at any span-wise location on the rotor blade 16 or any blade segment 20 thereof.

The rotor blade 16 may, in exemplary embodiments, be curved. Curving of the rotor blade 16 may entail bending the rotor blade 16 in a generally flapwise direction and/or in a generally edgewise direction. The flapwise direction is a direction substantially perpendicular to a transverse axis through a cross-section of the widest side of the rotor blade 16. Alternatively, the flapwise direction may be construed as the direction (or the opposite direction) in which the aerodynamic lift acts on the rotor blade 16. The edgewise direction is perpendicular to the flapwise direction. Flapwise curvature of the rotor blade 16 is also known as pre-bend, while edgewise curvature is also known as sweep. Thus, a curved rotor blade 16 may be pre-bent and/or swept. Curving may enable the rotor blade 16 to better withstand flapwise and edgewise loads during operation of the wind turbine 10, and may further provide clearance for the rotor blade 16 from the tower 12 during operation of the wind turbine 10.

FIGS. 2 through 8 illustrate various embodiments of a joint 50 for connecting adjacent blade segments 20, such as first blade segment 52 and second blade segment 54 as shown, of a rotor blade 16. It should be understood that first blade segment 52 and second blade segment 54 may be any suitable adjacent blade segments 20. For example, in some embodiments as shown in FIG. 2, first blade segment 52 may extend from blade tip 22 and second blade segment 54 may extend from blade root 24. In other embodiments, first blade segment 52 may extend from blade tip 22 and second blade segment 54 may be an intermediate blade segment 20, or first blade segment 52 may be an intermediate blade segment 20 and second blade segment 54 may extend from blade root 24, or both first blade segment 52 and second blade segment 54 may be intermediate blade segments 20.

Joints 50 according to the present disclosure advantageously allow for more efficient and on-site connection of adjacent blade segments 20. For example, a joint 50 allows for access to and connection of blade segments 20 from external to the joint 50 and blade segments 20. Additionally, joint 50 utilizes mechanical fasteners for connection to at least one of the adjacent blade segments 20, thus allowing for easier connection and inspection thereof. Such joints 50 further allow for disassembly of the various adjacent blade segments 20 after the rotor blade 16 has been formed, thus allowing the removal of individual blade segments 20 for inspection, maintenance, replacement, or upgrading.

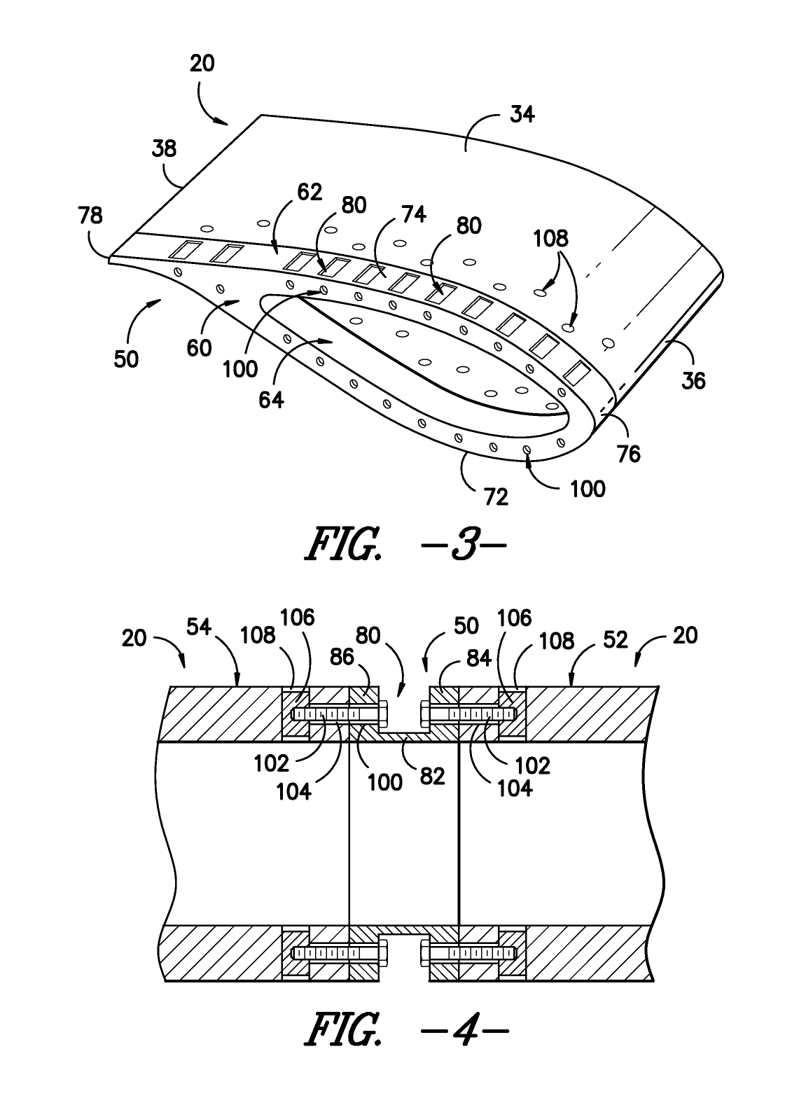

As shown in FIGS. 3 through 8, a joint 50 according to the present disclosure includes a body 60. The body includes an outer surface 62 and an inner surface 64. Outer surface 62 generally faces the exterior of the rotor blade 16, while inner surface 64 generally faces the interior of the rotor blade 16. The body 60 further includes a pressure side 72 and a suction side 74 extending between a leading edge 76 and a trailing edge 78, and thus has a generally aerodynamic contour. Outer surface 62 generally defines the pressure side 72, suction side 74, leading edge 76, and trailing edge 78, as shown, and thus further has the aerodynamic contour. Further, the aerodynamic contour of the outer surface 62 and body 60 generally corresponds to the aerodynamic contour of the adjacent blade segments 20 to be connected by the joint 50, such as first blade segment 52 and second blade segment 54. Thus, a generally continuous aerodynamic contour is defined by the connected adjacent blade segments 20 and joint 50.

The outer surface 62 further defines at least one channel 80. As shown, in some exemplary embodiments each channel 80 may include a base wall 82 extending between opposing sidewalls 84 and 86. It should be understood that the base wall 82 and sidewalls 84 and 86 may each be generally planer, as shown, or may be generally curvilinear. Further, it should be noted that the opposing sidewalls 84 and 86 need not be parallel to one another, but rather may be parallel or at any suitable angle to each other, and that the base wall 82 need not be perpendicular to the sidewalls 84 and 86, but rather may be perpendicular or at any suitable angle to them. It should further be understood that in other embodiments, each channel 80 need not include a base wall 82, and rather may simply include opposing sidewalls 84 and 86.

In some embodiments as shown, base wall 82 may be a generally continuous base wall 82. Thus, in these embodiments, the base wall 82 may be generally solid, with generally no apertures or breaks therein. Access to the channel 80 from internal to the joint 50 is thus prevented. In other embodiments, however, the base wall 82 need not be generally continuous. Further, the inner surface 64 may include, and thus form, the base wall 82. Thus, the inner surface 64 in some embodiments may similarly generally be continuous.

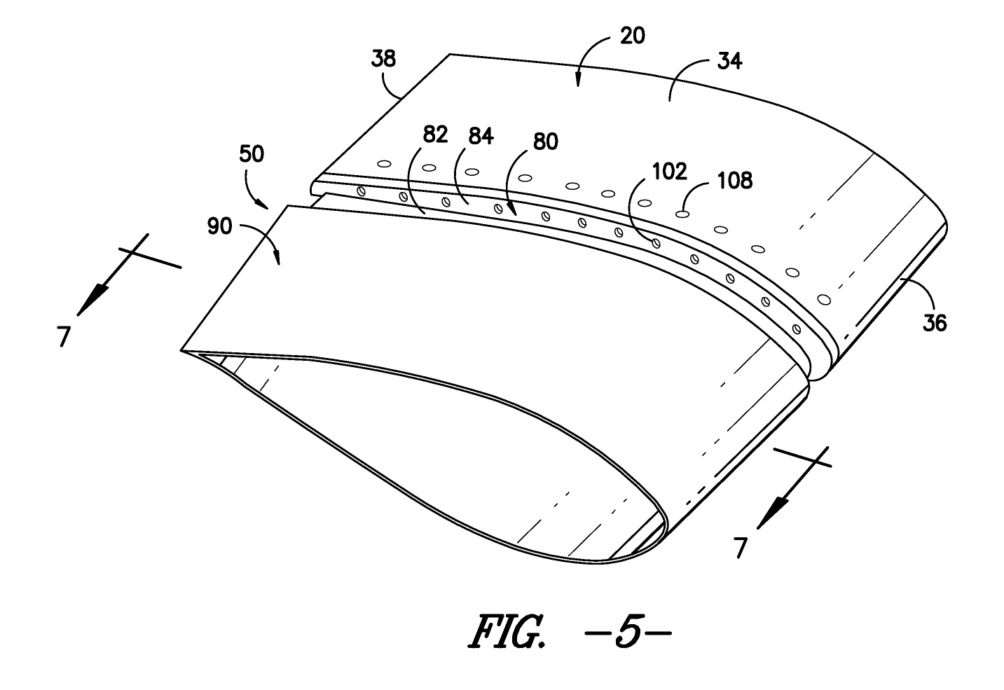

FIGS. 3 and 8, for example, illustrate a plurality of channels 80. The channels 80 are defined in a generally chord-wise array about the outer surface 62. Thus, channels 80 may be defined in any of the pressure side 72, suction side 74, leading edge 76, and/or trailing edge 78. Further, as shown in FIG. 5, one channel 80 may be defined continuously in portions or all of one or more of the pressure side 72, suction side 74, leading edge 76, and/or trailing edge 78. One of the channels 80 defined in the outer surface 62 of FIG. 8, for example, extends continuously through the leading edge 76 and at least a portion of the pressure side 72 and suction side 74 in the generally chord-wise direction.

In other embodiments, as shown in FIG. 5, a joint 50 may include one continuous channel 80. The continuous channel 80 may extend in the generally chord-wise direction through all of the pressure side 72, suction side 74, leading edge 76, and trailing edge 78, as shown.

In some embodiments, as shown in FIGS. 5 through 7, a joint 50 according to the present disclosure may further include one or more shells 90 extending from the body 60. A shell 90 may extend in the generally span-wise direction. Further, a shell 90 may extend from sidewall 84 or sidewall 86. Each shell 90 may have a generally aerodynamic contour, thus defining a pressure side, suction side, leading edge, and trailing edge as shown. Further, however, the shell 90 may taper in one or more directions.

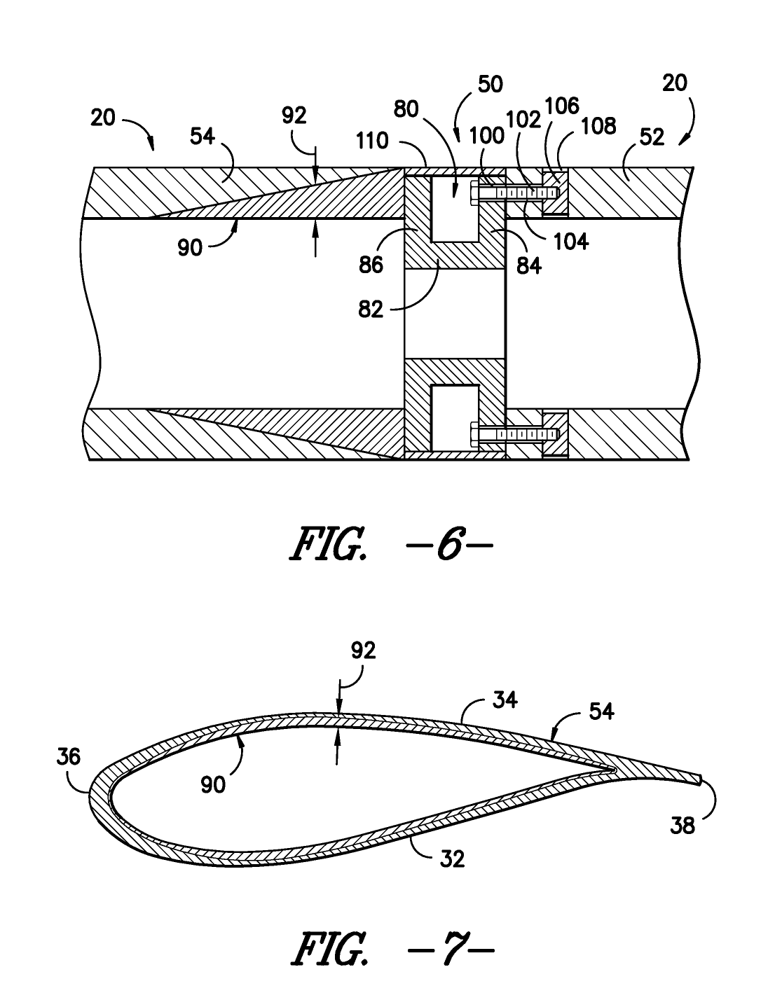

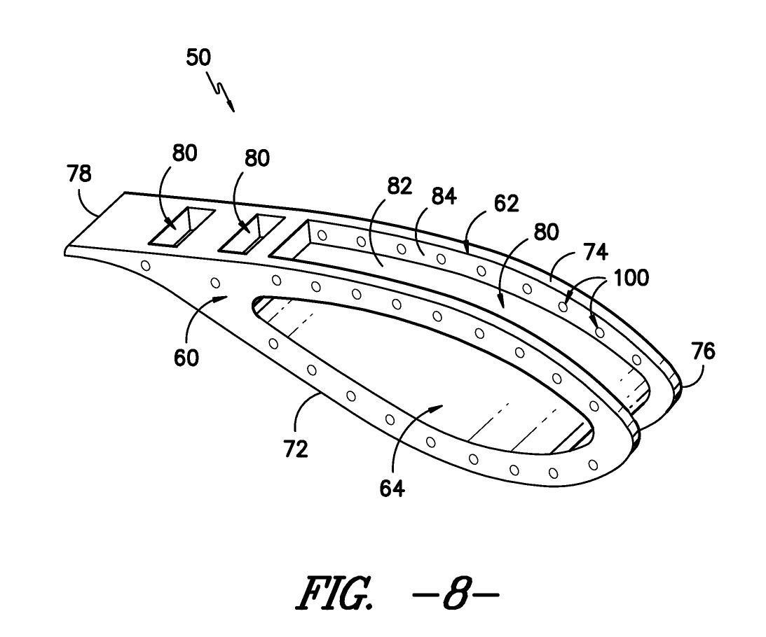

For example, the shell 90 may define a thickness 92. The thickness 92 may taper in the generally span-wise direction and/or the generally chord-wise direction. FIG. 6 illustrates the thickness 92 tapering from the body 60 in the generally span-wise direction. FIG. 7 illustrates the thickness 92 tapering in the generally chord-wise direction. The chord-wise taper may generally occur from any suitable chord-wise location on the pressure side and suction side of the shell towards the leading edge and the trailing edge. Such tapering of the shell 90 may allow the shell 90 to fit within an blade segment 20, such as first blade segment 52 or second blade segment 54. It should be noted that such blade segment 20 may have a corresponding taper, as shown in FIG. 6, for connecting with the shell 90.

The shell 90 may, in some embodiments, be adapted for bonding to an adjacent blade segment 20, such as first blade segment 52 or second blade segment 54. Thus, the shell 90 may be sized and tapered as required to fit within and contact the adjacent blade segment 20, as discussed above. The shell 90 may be bonded to the blade segment 20 through welding, a suitable adhesive, infusion, or any other suitable bonding technique, thus connecting the shell 90 and joint 50 in general to the blade segment 20. In other embodiments, the shell 90 may be fastened to the adjacent blade segment 20 using one or more suitable mechanical fasteners, such as nut/bolt combinations, nails, screws, rivets, etc.

As shown in FIGS. 3 through 8, one or both opposing sidewalls 84 and 86 may each define one or more bore holes 100. The bore holes 100 may be provided for accepting mechanical fasteners therethrough to fasten a joint 50 to one or more adjacent blade segments 20, thus connecting the joint 50 and blade segment 20. Further a mechanical fastener may be adapted to extend through a bore hole 100 and fasten the joint to a blade segment 20, such as first blade segment 52 or second blade segment 54.

In some embodiments as shown in FIGS. 4 and 6, for example, a mechanical fastener may include a bolt 102. The bolt 102 may extend through the bore hole 100. The bolt 102 may further extend through a bore hole 104 defined in the adjacent blade segment 20, which may be aligned with the bore hole 100. In exemplary embodiments, a barrel nut 106 may further be aligned with the bore holes 100 and 104. The barrel nut 106 may be positioned within a bore hole 108 defined in the adjacent blade segment 20, which may extend adjacent to bore hole 104 from the interior or exterior, as shown, of the blade segment 20. The bolt 102 and barrel nut 106 may be fastened together, thereby fastening the joint 50 to the blade segment 20.

In some embodiments, the joint 50 further includes one or more cover skins 110, as shown in FIG. 6. The cover skins 110 may be connected to the outer surface 62, and may cover the channels 80. By covering the channels 80, the cover skins 110 may form a portion of the generally aerodynamic contour of the assembled rotor blade 16. A cover skin 80 may be connected to the outer surface 62 by any suitable devices or methods, such as bonding or the use of mechanical fasteners.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A joint for connecting a first blade segment and a second blade segment of a wind turbine rotor blade, the joint comprising:
a body comprising an outer surface and an inner surface, the outer surface having an aerodynamic contour that generally corresponds to an aerodynamic contour of the first blade segment and the second blade segment, the body comprising a pressure side and a suction side extending between a leading edge and a trailing edge; and,
a channel defined in the outer surface of the body, the channel comprising a generally continuous base wall extending between opposing sidewalls, the inner surface comprising the base wall.

2. The joint of claim 1, further comprising a plurality of channels, the plurality of channels defined in a generally chord-wise array.

3. The joint of claim 2, wherein one of the plurality of channels extends continuously through the leading edge and at least a portion of the pressure side and the suction side in a generally chord-wise direction.

4. The joint of claim 1, wherein the channel is continuous in a generally chord-wise direction.

5. The joint of claim 1, wherein one of the opposing sidewalls defines a bore hole.

6. The joint of claim 5, further comprising a mechanical fastener adapted to extend through the bore hole and fasten the joint to one of the first blade segment or the second blade segment.

7. The joint of claim 1, further comprising a shell extending from the body in a generally span-wise direction and having a generally aerodynamic contour, a thickness of the shell tapering from the body in the generally span-wise direction.

8. The joint of claim 7, wherein the thickness of the shell further tapers in a generally chord-wise direction.

9. The joint of claim 7, wherein the shell is adapted for bonding to one of the first blade segment or the second blade segment.

10. The joint of claim 1, further comprising a cover skin connected to the outer surface and covering the channel.

11. A joint for connecting a first blade segment and a second blade segment of a wind turbine rotor blade, the joint comprising:
a body comprising an outer surface and an inner surface, the outer surface having an aerodynamic contour that generally corresponds to an aerodynamic contour of the first blade segment and the second blade segment, the body comprising a pressure side and a suction side extending between a leading edge and a trailing edge;
a channel defined in the body; and,
a shell extending from the body in a generally span-wise direction and having a generally aerodynamic contour, a thickness of the shell tapering from the body in the generally span-wise direction.

12. The joint of claim 11, further comprising a plurality of channels, the plurality of channels defined in a generally chord-wise array.

13. The joint of claim 12, wherein one of the plurality of channels extends continuously through the leading edge and at least a portion of the pressure side and the suction side in a generally chord-wise direction.

14. The joint of claim 11, wherein the channel is continuous in a generally chord-wise direction.

15. The joint of claim 11, wherein the channel comprises a generally continuous base wall extending between opposing sidewalls, the inner surface comprising the base wall.

16. The joint of claim 15, wherein one of the opposing sidewalls defines a bore hole.

17. The joint of claim 16, further comprising a mechanical fastener adapted to extend through the bore hole and fasten the joint to one of the first blade segment or the second blade segment.

18. The joint of claim 11, wherein the thickness of the shell further tapers in a generally chord-wise direction.

19. The joint of claim 11, wherein the shell is adapted for bonding to one of the first blade segment or the second blade segment.

20. The joint of claim 11, further comprising a cover skin connected to the outer surface and covering the channel.
